(19) United States
(12) Patent Application Publication
(10) Pub. No.: US 2021/0110444 A1
(43) Pub. Date: Apr. 15, 2021

(54) FLIGHT ROUTE OPTIONS DETERMINATION SYSTEMS AND METHODS

(71) Applicant: THE BOEING COMPANY, Chicago, IL (US)

(72) Inventor: Mark T. Schwartz, Castle Rock, CO (US)

(73) Assignee: THE BOEING COMPANY, CHICAGO, IL (US)

(21) Appl. No.: 16/597,359

(22) Filed: Oct. 9, 2019

(51) Int. Cl. G06Q 30/02; G01C 21/20

(52) U.S. Cl. CPC G06Q 30/0283; G01C 21/20

(57) ABSTRACT

A flight route options determination system and method for determining flight route options to a destination airport. The flight route options determination system and method includes a flight route analysis control unit that receives flight route data indicative of flight routes to the destination airport, overflight charge data indicative of overflight charges for the flight routes to the destination airport, fuel costs data indicative of fuel costs for the flight routes to the destination airport, and contact data indicative of contacts for the flight routes to the destination airport. The flight route analysis control unit determines total costs for the flight routes based, at least in part, on the overflight charge data and the fuel costs data.

### FIELD OF THE DISCLOSURE

Embodiments of the present disclosure generally relate to systems and methods for determining flight route options between a departure airport and a destination airport.

### BACKGROUND OF THE DISCLOSURE

Aircraft are used to transport passengers and cargo between various locations. Numerous aircraft depart from and arrive at a typical airport every day.

While planning a flight between locations, an aircraft operator may have different route options. For example, numerous planned routes may exist between different airports. Each route may vary in terms in total time, distance, and costs.

A route between two different locations may pass through airspace of multiple different countries. Most countries charge aircraft operators for travel through airspace and also air traffic control services. Overflight charges for each country typically include an entry fee and distance traveled fee. An entry fee is a charge for entering the airspace of a particular country. The distance traveled fee is a charge for distance traveled through the airspace of a particular country.

Overflight charges for different countries typically vary. The overflight charges for one country may be substantially higher than another country.

Accordingly, pilots often consider such overflight charges for different countries when planning a flight. While a first route between two locations may be the shortest distance, the first route may also cost substantially more than a second route, which may be longer, due to overflight charges over a particular country.

Typically, an aircraft operator contacts different regulatory agencies for different countries to determine the overflight charges. The aircraft operator then manually calculates the cost of a particular route. The aircraft operator repeats this process for each route.

As can be appreciated, the process of contacting various agencies and manually determining flight costs to plan a flight is time and labor intensive. Consequently, the time and cost of a flight may also increase.

### SUMMARY OF THE DISCLOSURE

A need exists for an efficient system and method of planning a flight between locations. Further, a need exists for a system and method that automatically determine flight costs for different routes. Moreover, a need exists for a system and method of presenting flight costs for different routes to an aircraft operator in a readily discernable and understandable manner, thereby allowing the aircraft operator to choose a suitable route to a destination.

With those needs in mind, certain embodiments of the present disclosure provide a flight route options determination system for determining flight route options to a destination airport. The flight route options determination system includes a flight route analysis control unit that receives flight route data indicative of flight routes to the destination airport, overflight charge data indicative of overflight charges for the flight routes to the destination airport, fuel costs data indicative of fuel costs for the flight routes to the destination airport, and contact data indicative of contacts for the flight routes to the destination airport. The flight route analysis control unit determines total costs for the flight routes based, at least in part, on the overflight charge data and the fuel costs data.

In at least one embodiment, a user interface is in communication with the flight route analysis control unit. The flight route analysis control unit presents the total costs and times for the flight routes on the user interface. The flight route analysis control unit can also present the contacts for the flight routes on the user interface.

As an example, the user interface is onboard an aircraft, and the flight route analysis control unit is remote from the aircraft. As another example, the user interface and the flight route analysis control unit are onboard an aircraft.

In at least one embodiment, the flight route analysis control unit shows on a display of the user interface each of the flight routes to the destination, times to the destination for each of the flight routes, the overflight charges for each of the flight routes, the fuel costs for each of the flight routes, and the contacts for each of the flight routes.

The overflight charge data can include entry fee data and distance traveled fee data for a plurality of areas. The entry fee data can include information regarding fees for entering airspace of each of the plurality of areas. The distance traveled fee data can include information regarding distance traveled fees within each of the plurality of areas. The contact data can include information regarding contacts for requesting permission to fly into and through an area.

Certain embodiments of the present disclosure provide a flight route options determination method for determining flight route options to a destination airport. The flight route options determination method includes receiving, by a flight route analysis control unit, flight route data indicative of flight routes to the destination airport, overflight charge data indicative of overflight charges for the flight routes to the destination airport, fuel costs data indicative of fuel costs for the flight routes to the destination airport, and contact data indicative of contacts for the flight routes to the destination airport, and determining, by the flight route analysis control unit, total costs for the flight routes based, at least in part, on the overflight charge data and the fuel costs data.

In at least one embodiment, the flight route options determination method also includes presenting or otherwise facilitating, by the flight route analysis control unit, the total costs, times, and/or contacts for the flight routes on a user interface in communication with the flight route analysis control unit.

As an example, the flight route options determination method can include providing the user interface onboard an aircraft, and remotely locating the flight route analysis control unit from the aircraft. As another example, the flight route options determination method can include providing the user interface and the flight route analysis control unit onboard an aircraft.

In at least one embodiment, the flight route options determination method includes showing, by the flight route analysis control unit, on a display of the user interface each of the flight routes to the destination, times to the destination for each of the flight routes, the overflight charges for each of the flight routes, the fuel costs for each of the flight routes, and the contacts for each of the flight routes.

Certain embodiments of the present disclosure provide a non-transitory computer-readable storage medium comprising executable instructions that, in response to execution, cause a flight route options determination system comprising a processor, to perform operations comprising: receiving flight route data indicative of flight routes to the destination airport, overflight charge data indicative of overflight charges for the flight routes to the destination airport, and fuel costs data indicative of fuel costs for the flight routes to the destination airport, based, at least in part, on the overflight charge data and the fuel costs data, determining total costs data indicative of total costs associated with the flight routes, and facilitating a transmission of the total costs data to a user interface, wherein total costs data is to be displayed via the user interface, wherein the flight route analysis control unit determines total costs for the flight routes based, at least in part, on the overflight charge data and the fuel costs data.

### BRIEF DESCRIPTION OF THE DRAWINGS

FIG. 1 illustrates a simplified block diagram of a flight route options determination system, according to an embodiment of the present disclosure.

FIG. 2 illustrates a simplified map of various flight routes between a departure airport and a destination airport, according to an embodiment of the present disclosure.

FIG. 3 illustrates a front view of a display of a user interface showing cost information for various flight routes, according to an embodiment of the present disclosure.

FIG. 4 illustrates a flow chart of a flight route options determination method, according to an embodiment of the present disclosure.

FIG. 5 illustrates a schematic block diagram of a flight route analysis control unit, according to an embodiment of the present disclosure.

FIG. 6 illustrates a front perspective view of an aircraft, according to an exemplary embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Certain embodiments of the present disclosure provide a flight route options determination system and method that determine costs for different flight routes between locations. The flight route options determination system and method provide a concise overview of the flight routes, including various factors for consideration. The flight route options determination system and method allow an aircraft operator to choose a particular flight route based on preferences regarding total costs, time of flight, and the like. In at least one embodiment, a flight route analysis control unit analyzes overflight charges, including entry fee data and distance traveled data, in relation to multiple routes to provide an aircraft operator with total costs for each route. Embodiments of the present disclosure provide aircraft operators with flight route information, including costs, in an easily-accessible format.

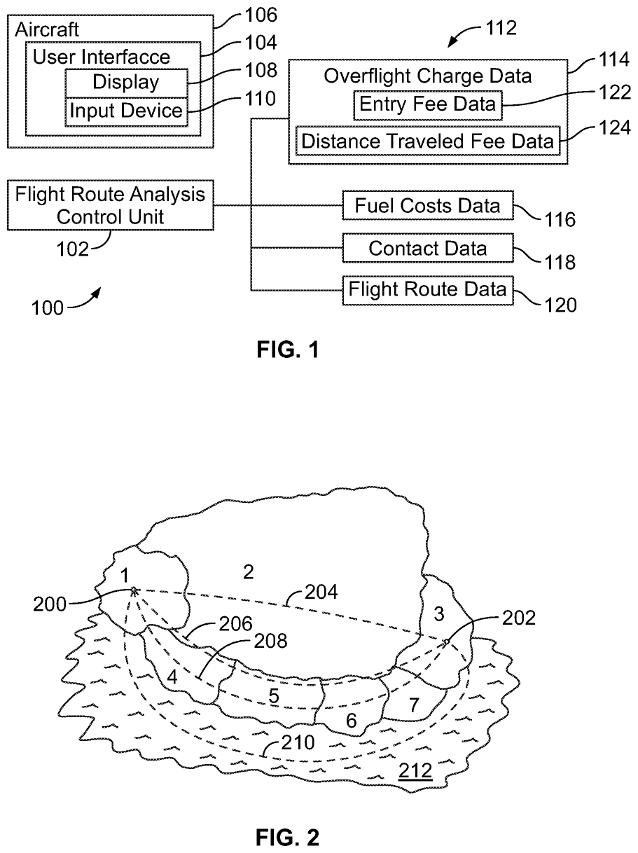

FIG. 1 illustrates a simplified block diagram of a flight route options determination system 100, according to an exemplary embodiment of the present disclosure. The flight route options determination system 100 includes a flight route analysis control unit 102 in communication with a user interface 104, which can be onboard an aircraft 106.

The flight route analysis control unit 102 can be remotely located from a location of the user interface 104, or can optionally be co-located with the user interface 104. For example, the flight route analysis control unit 102 can be at a land-based monitoring location, while the user interface 104 is onboard the aircraft 106. As another example, the flight route analysis control unit 102 and the user interface 104 can both be onboard the aircraft 106.

The flight route analysis control unit 102 and the user interface 104 can be in communication through one or more wired (if at the same location), or wireless connections. For example, the flight route analysis control unit 102 and the user interface 104 can include communication devices, such as antennas, transceivers, and/or the like, which allow for wireless communication therebetween. As another example, the flight route analysis control unit 102 and the user interface 104 can be in communication through an intermediate medium, such as through the Internet, a private communication network, and/or the like.

In at least one embodiment, the user interface 104 can be part of a flight computer of the aircraft 106. As another example, the user interface 104 can be part of a separate computer workstation aboard the aircraft 106. As another example, the user interface 104 can be a handheld device, such as a smart phone, table, or the like, within the aircraft 106. As another example, the user interface 104 can be remotely located from the aircraft 106, such as at a flight planning center.

The user interface 104 includes a display 108 and an input device 110, both of which can be in communication with an operational control unit. The display 108 can be a monitor, screen, television, touchscreen, and/or the like. The input device 110 can include a keyboard, mouse, stylus, touchscreen interface (that is, the input device 110 may be integral with the display 108), and/or the like.

Route options data 112 is input into the flight route analysis control unit 102. For example, the flight route analysis control unit receives, retrieves, or otherwise acquires route options data 112 from a variety of sources. The route options data 112 can be stored in one or more data stores. As another example, the route options data 112 can be stored on or within various networks, the internet, or the like. The route options data 112 includes overflight charge data 114, fuel costs data 116, contact data 118, and/or flight route data 120.

The overflight charge data 114 can be stored in an overflight charge data stores, located within a communication network, or the like. The overflight charge data 114 includes overflight data for various areas, such as countries or groups of countries. The overflight charge data 114 include entry fee data 122 and distance traveled fee data 124. The entry fee data 122 includes information regarding fees for entering airspace of different areas. The distance traveled fee data 124 includes information regarding distance traveled fees, such as charges per unit of distance (such as charges per kilometer or mile) within different areas. For example, a first country can charge a first entry fee for entering the airspace of the first country, and a first charge per kilometer flown within the airspace of the first country. A second country can charge a second entry fee for entering the airspace of the second country, and a second charge per kilometer flown with the airspace of the second country. The first entry fee is greater or less than the second entry fee, and the first charge per kilometer flown is greater or less than the second charge per kilometer flown.

The fuel costs data 116 can be stored in a fuel costs data stores, located within a communication network, or the like. The fuel costs data 116 includes information regarding the costs of fuel per gallon, costs of fuel burn during a flight, and/or the like.

The contact data 118 can be stored in a contact data store, located within a communication network, or the like. The contact data 118 includes information regarding contacts for requesting permission to fly into and through an area, as well as for payment of overflight charges. For example, the contacts can include regulatory agencies for different areas, such as countries or groups of countries.

The flight route data 120 can be stored in a flight route data store, located within a communication network, or the like. The flight route data 120 includes information regarding flight routes between departures airports and destination airports. For example, the flight routes can be predetermined and set. In at least one embodiment, an aircraft operator can input the flight route data 120 into the flight route analysis control unit 102 through the user interface 104. For example, the aircraft operator can determine the flight routes and input them into the flight route analysis control unit 102.

In operation, the aircraft 106 is located at a departure airport and is to fly to a destination airport. The flight route analysis control unit 102 receives the flight route data 120 including the possible flight routes from the departure airport to the destination airport. Each flight route can pass through the airspace of different areas, such as countries or groups of countries. Accordingly, the flight route analysis control unit 102 receives the overflight charge data 114 and associates the flight route data 120 with the overflight charge data 114. For example, for each flight route, the flight route analysis control unit 102 determines the entry fees, such as within the entry fee data 122, and the distances traveled fees, such as within the distance traveled fee data 124, for the particular route.

In at least one embodiment, the flight analysis control unit 202 can also receive aircraft related data, such as a number of seats and/or passengers onboard the aircraft. The flight analysis control unit 102 can determine overflight charge fees based, at least in part, the aircraft related data.

The flight route analysis control unit 102 also receives the fuel costs, as stored in the fuel costs data 116, for the particular routes. For example, the flight route analysis control unit 102 determines the amount of fuel required to fly for each route (for example, the amount of fuel to fly the distance of the route), the price per unit of fuel (for example, price per gallon), and, accordingly, the fuel costs for each route.

The flight route analysis control unit 102 also receives the contact information, as stored in the contacts data 118, for the regulatory agencies to be contacted in order to fly the particular routes. For example, if flying through three different areas, three different regulatory agencies are to be contacted to request permission to fly through the airspace of the three areas, as well as to pay for the overflight charges.

The flight route analysis control unit 102 then communicates with the user interface 104 to provide costs information for each route. For example, the flight route analysis control unit 102 can show on the display 108 of the user interface 104 each route to the destination, as well as time to destination (such as through the flight route data 120) for each route, the overflight charges (such as through the overflight charge data 114) for each route, the fuel costs (such as through the fuel costs data 116), and the necessary contacts to grant permission for flight and/or payment (such as through the contact data 118). Based on the information presented on the user interface 104, an aircraft operator can easily and readily discern a preferred flight route. For example, the aircraft operator can opt for the quickest route to the destination, despite increased overflight charges, a longer route having lower overflight charges, and/or the like.

As described herein, the flight route options determination system 100 includes the flight route analysis control unit 102, which receives the flight route data 120 indicative of flight routes to a destination airport, the overflight charge data 114 indicative of overflight charges for the flight routes to the destination airport, the fuel costs data 116 indicative of fuel costs for the flight routes to the destination airport, and the contact data 118 indicative of contacts (for example, necessary regulatory agencies) for the flight routes to the destination airport. The flight route analysis control unit 102 determines total costs and times for each of the flight routes based, at least in part, on the overflight charge data 114 and the fuel costs data 116. In at least one embodiment, the flight route analysis control unit 102 can receive data regarding potential delays (such as weather data from a weather forecasting system). The flight route analysis control unit 102 can determine times for flights that include the potential delays. The user interface 104 is in communication with the flight route analysis control unit 102. The flight route analysis control unit 102 presents the total costs and the times for each of the flight routes on the user interface. 104, such as on the display 108. In at least one embodiment, the flight route analysis control unit 102 presents the contacts for each of the flight routes on the user interface 104.

FIG. 2 illustrate a simplified map of various flight routes between a departure airport 200 and a destination airport 202, according to an embodiment of the present disclosure. The departure airport 200 is in a first area 1, such as a first country. A first flight route 204 is the shortest distance and shortest time between the departure airport 200 and the destination airport and travels through the airspace of a second area 2, such as a second country or group of countries, and to the destination airport 202 in a third area 3, such as a third country. While the distance and time for a flight over the first flight route 204 can be the shortest, the overflight charges through the second area 2, such as an entry fee and distance traveled fee, can be excessive.

Accordingly, a second flight route 206, which is longer than the first flight route 204, can travel briefly through the second area 2, then into a fourth area 4, a fifth area 5, a sixth area 6, back into the second area 2, and to the destination airport 202 in the third area 3. However, the overflight charges including the entry fees into the second area 2, along with the entry fees into the fourth area, the fifth area, and the sixth area, as well as distances traveled fees for each area, can be relatively high.

As such, a third flight route 208, which is longer than the first flight route 204 and the second flight route 206, bypasses the second area 2, and travels through the fourth area 4, the fifth area 5, the sixth area 6, a seventh area 7, and into the destination airport 202 in the third area 3. In this manner, the third flight route 208 does not incur the overflight charges of the second area 2, which can be excessive, but can be substantially longer than the first flight route 204, and therefore incur excessive fuel costs. However, the additional fuel costs can be less than the excessive overflight charges through the second area 2.

As another option, a fourth flight route 210 can bypass the second area 2, the fourth area 4, the fifth area 5, the sixth area 6, and the seventh area 7, and instead pass over international water 212 (such as an ocean or sea). As such, the fourth flight route 210 can have the lowest amount of overflight charges, but can take the longest time, and burn the most fuel (and therefore have the highest fuel costs).

Referring to FIGS. 1 and 2, the flight route analysis control unit 102 determines the total costs for each flight route 204, 206, 208, and 210, and presents costs, time and/or distance to an aircraft operator on the user interface 104, for example. It is to be understood that the map shown on FIG. 2 is a simplified, general map, and is not meant to depict any existing country. Further, more or less routes than shown can exist between a departure airport and a destination airport.

In at least one embodiment, the flight route analysis control unit 102 iteratively determines the total costs for the flight routes, and presents costs, time and/or distance to the aircraft operator on the user interface 104. In at least one embodiment, the flight route analysis control unit 102 continually and/or periodically performs such analysis over a time period, such as an hour, day, week, or longer prior to a flight, until the time of departure. Costs for each flight route can change over time. As such, the flight route analysis control unit 102 can continually analyze data to determine which flight route represents a lowest cost, and/or a desired combination of costs and other factors, such as contact information, time of flight, and/or the like. Notably, one aircraft operator can desire one flight route, while another aircraft operator can desire a different flight route for various reasons.

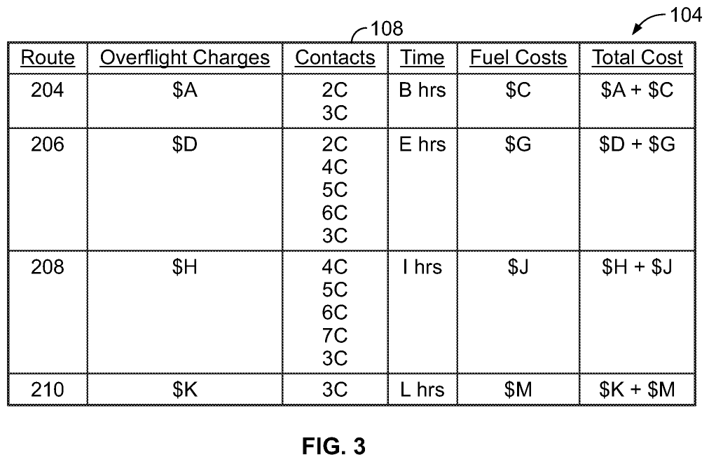

FIG. 3 illustrates a front view of the display 108 of the user interface 104 showing cost information for various flight routes 204, 206, 208, and 210, according to an embodiment of the present disclosure. Referring to FIG. 103, the flight route analysis control unit 102 receives the flight route data 120 regarding each of the flight routes 204, 206, 208, and 210. The flight route analysis control unit 102 also receives the overflight charge data 114, the fuel costs data 116, and the contact data 118, which the flight route analysis control unit 102 associates with the flight routes 204, 206, 208, and 210. The flight route analysis control unit 102 then shows the various costs, contacts, and time for each of the flight routes 204, 206, 208, and 210 on the display 108. The flight route analysis control unit 102 can show more or less information on the display 108 than shown in FIG. 3. For example, the flight route analysis control unit 102 can show total distance for each flight route 204, 206, 208, and 210 in addition to, or in place of the time for each flight route 204, 206, 208, and 210.

The overflight charges $A for the first flight route 204 can be greater than the overflight charges for the other flight routes 206, 208, and 210. However, the fuel charges $C for the first flight route 204 can be the least as compared to the other flight routes 204, 208, and 210, and the time B hours can be the shortest. However, the total costs $A+$C can be the greater than at least one other flight route 206, 208, and 210. Further, as shown, a flight operator can need to contact only 2C and 3C for the first flight route 204. As such, a flight operator can opt for the first flight route 204 due to the shortest amount of time, as well as the relatively low number of regulatory agencies to contact.

In contrast, the overflight charges $D for the second flight route 206 can be less than $A, but greater than the overflight charges $H and $K for the respective third flight route 208 and the fourth flight route 210. However, the second flight route 206 and the third flight route 208 require a greater number of contacts than the first flight route 204. An aircraft operator can opt for the second flight route 206 or the third flight route 208 to save on total costs, even though there are more regulatory agencies to contact.

The fourth flight route 210 can have the lowest overflight charges $K, but the highest fuel costs $M, and the longest time L hrs. However, the increased fuel costs can be offset by the reduction in overflight charges.

In at least one embodiment, an operator can indicate a preference regarding a route via the user interface 104. For example, the operator can indicate a preference for a shortest route, a least costly route, a minimum number of contacts, and/or the like. The flight route analysis control unit 102 receives preference data, as input via the user interface 104, and presents a recommendation regarding the route that accords with such preference data to the operator on the user interface 104. The flight route analysis control unit 102 can provide not only the total costs, but a recommendation regarding a route (such as a preferred route based on preference data), depending on whether overflight costs, fuel costs, or other costs are more significant for a given route. As an example, the flight route analysis control unit 102 applies weightings to the parameters shown in FIG. 3 based on the preference data, and ranks the routes accordingly. The flight route analysis control unit 102 can then present the route that accords with the preference data, and/or present an ascending or descending order of the routes based on the preference data. In at least one embodiment, the route that is in accord with the preference data may be highlighted on the user interface 104.

In at least one other embodiment, a route (such as a selected route, a preferred route, a highest ranked route based on preference data, and/or selected based on defined criteria, such as shortest time, least contacts, etc.) is automatically selected and provided an input to a navigation system of the aircraft. Therefore, the aircraft can be automatically navigated to a destination based on the input route.

In general, the flight route analysis control unit 102 provides various types information, such as that shown in FIG. 3, to the aircraft operator. As such, the aircraft operator can choose a desired flight route based on preferences, such as lowest cost, shortest time, or a combination of thereof (for example, increased cost, but not the highest cost, and longer time, but not the longest time).

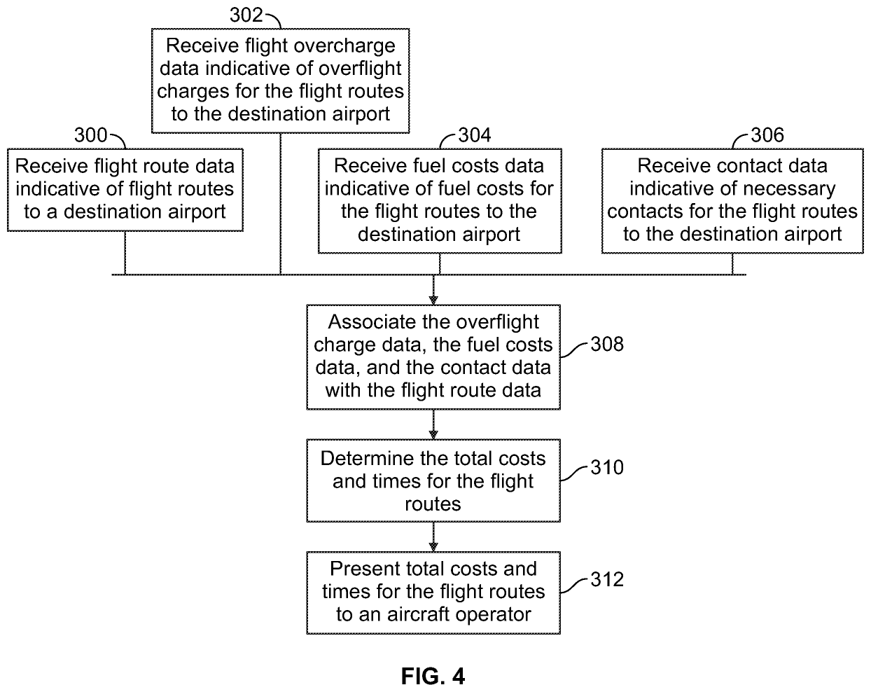

FIG. 4 illustrates a flow chart of a flight route options determination method, according to an embodiment of the present disclosure. Referring to FIGS. 1 and 4, at 300, the flight route analysis control unit 102 receives the flight route data 120 indicative of flight routes to a destination airport. At 302, the flight route analysis control unit 102 receives the overflight charge data 114 indicative of overflight charges for the flight charges to the destination airport. At 304, the flight route analysis control unit 102 receives the fuel costs data indicative of fuel costs for the flight routes to the destination airport. At 306, the flight route analysis control unit 102 receives the contact data 118 indicative of necessary contacts (for example, regulatory agencies) for the flight routes to the destination airport.

At 308, the flight route analysis control unit 102 associates the overflight charge data 114, the fuel costs data 116, and the contact data 118 with the flight route data 120. For example, for each flight route, the flight route analysis control unit 102 associates a particular overflight charge, fuel costs, and contact data. The flight route analysis control unit 102 can determine overflight charges, such as entry fees and distance traveled fees, by analyzing the paths and distances through particular areas. For example, a distance traveled fee of $Y/seat/kilometer traveled through an area is multiplied by the distance in kilometers traveled through the area based on the flight route. Further, an entry fee of $Z is determined by the points of entry of areas along the flight route. In at least one embodiment, step 308 can be part of steps 300, 302, 304, and 306.

At 310, the flight route analysis control unit 102 determines the total costs and times for the flight routes. At 312, the flight route analysis control unit 102 presents the total costs and times for the flight routes to an aircraft operator, such as on the user interface 104.

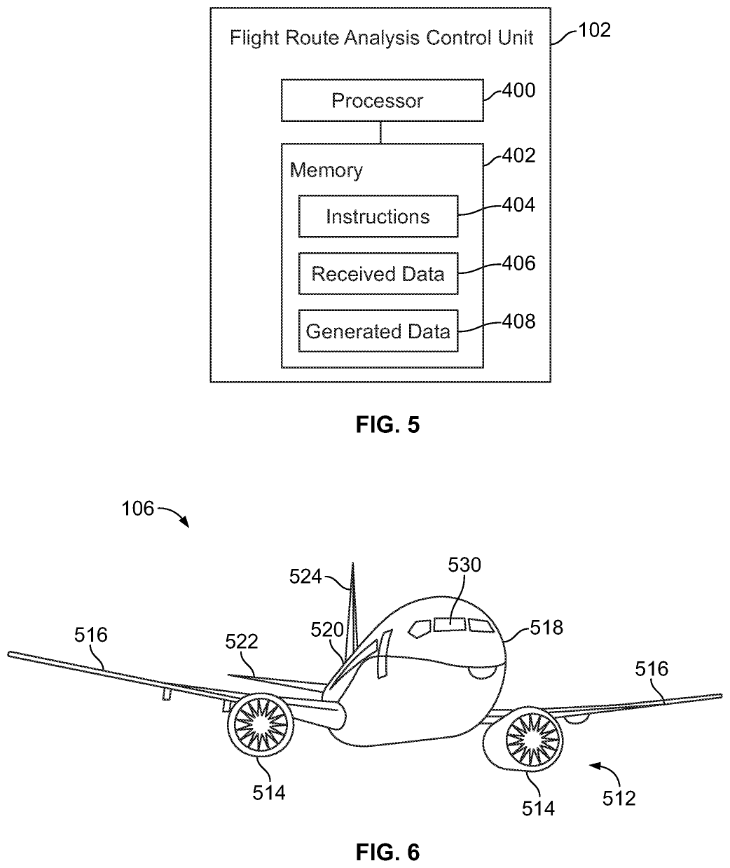

FIG. 5 illustrates a schematic block diagram of the flight route analysis control unit 102, according to an embodiment of the present disclosure. In at least one embodiment, the flight route analysis control unit 102 includes at least one processor 400 in communication with a memory 402. The memory 402 stores instructions 404, received data 406, and generated data 408. The flight route analysis control unit 102 shown in FIG. 5 is merely exemplary, and non-limiting.

As used herein, the term “control unit,” “central processing unit,” “unit,” “CPU,” “computer,” or the like can include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the flight route analysis control unit 102 can be or include one or more processors that are configured to control operation thereof, as described herein.

The flight route analysis control unit 102 is configured to execute a set of instructions that are stored in one or more data storage units or elements (such as one or more memories), in order to process data. For example, the flight route analysis control unit 102 can include or be coupled to one or more memories. The data storage units can also store data or other information as desired or needed. The data storage units can be in the form of an information source or a physical memory element within a processing machine. The one or more data storage units or elements can comprise volatile memory or nonvolatile memory, or can include both volatile and nonvolatile memory. As an example, the nonvolatile memory can comprise read only memory (ROM), programmable ROM (PROM), electrically programmable ROM (EPROM), electrically erasable PROM (EEPROM), and/or flash memory and volatile memory can include random access memory (RAM), which can act as external cache memory. The data stores of the disclosed systems and methods is intended to comprise, without being limited to, these and any other suitable types of memory

The set of instructions can include various commands that instruct the flight route analysis control unit 102 as a processing machine to perform specific operations such as the methods and processes of the various embodiments of the subject matter described herein. The set of instructions can be in the form of a software program. The software can be in various forms such as system software or application software. Further, the software can be in the form of a collection of separate programs, a program subset within a larger program or a portion of a program. The software can also include modular programming in the form of object-oriented programming. The processing of input data by the processing machine can be in response to user commands, or in response to results of previous processing, or in response to a request made by another processing machine.

The diagrams of embodiments herein can illustrate one or more control or processing units, such as the flight route analysis control unit 102. It is to be understood that the processing or control units can represent circuits, circuitry, or portions thereof that can be implemented as hardware with associated instructions (e.g., software stored on a tangible and non-transitory computer readable storage medium, such as a computer hard drive, ROM, RAM, or the like) that perform the operations described herein. The hardware can include state machine circuitry hardwired to perform the functions described herein. Optionally, the hardware can include electronic circuits that include and/or are connected to one or more logic-based devices, such as microprocessors, processors, controllers, or the like. Optionally, the flight route analysis control unit 102 can represent processing circuitry such as one or more of a field programmable gate array (FPGA), application specific integrated circuit (ASIC), microprocessor(s), and/or the like. The circuits in various embodiments can be configured to execute one or more algorithms to perform functions described herein. The one or more algorithms can include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Embodiments of the present disclosure provide systems and methods that allow large amounts of data to be quickly and efficiently analyzed by a computing device. For example, numerous flight routes can exist between two locations. Various costs can be associated with each of the flight routes. As such, large amounts of data are being tracked and analyzed. The vast amounts of data are efficiently organized and/or analyzed by the flight route analysis control unit 102, as described above. The flight route analysis control unit 102 analyzes the data in a relatively short time in order to quickly and efficiently output and/or display costs and times associated with the numerous flight routes. A human being would be incapable of efficiently analyzing such vast amounts of data in such a short time. As such, embodiments of the present disclosure provide increased and efficient functionality, and vastly superior performance in relation to a human being analyzing the vast amounts of data.

In at least one embodiment, components of the flight route options determination system 100, such as the flight route analysis control unit 102, provide and/or enable a computer system to operate as a special computer system for flight route analysis and selection.

FIG. 6 illustrates a front perspective view of the aircraft 106, according to an exemplary embodiment of the present disclosure. The aircraft 106 includes a propulsion system 512 that can include two engines 514, for example. Optionally, the propulsion system 512 can include more engines 514 than shown. The engines 514 are carried by wings 516 of the aircraft 106. In other embodiments, the engines 514 can be carried by a fuselage 518 and/or an empennage 520. The empennage 520 can also support horizontal stabilizers 522 and a vertical stabilizer 524. The fuselage 518 of the aircraft 106 defines an internal cabin, which can include a cockpit 530, one or more work sections (for example, galleys, personnel carry-on baggage areas, and the like), and/or one or more passenger sections.

As described herein, embodiments of the present disclosure provide efficient and effective systems and methods of planning a flight between locations. Further, embodiments of the present disclosure provide systems and methods that automatically determine flight costs for different routes to a destination. Moreover, embodiments of the present disclosure provide systems and methods of presenting flight costs for different routes to an aircraft operator in a readily discernable and understandable manner, thereby allowing the aircraft operator to choose a suitable route to a destination.

Further, the disclosure comprises embodiments according to the following clauses:

Clause 1. A system comprising:

a flight route analysis control unit that receives flight route data indicative of flight routes to a destination airport, overflight charge data indicative of overflight charges for the flight routes to the destination airport, and fuel costs data indicative of fuel costs for the flight routes to the destination airport,

wherein the flight route analysis control unit determines information indicative of total costs for the flight routes based, at least in part, on the overflight charge data and the fuel costs data.

Clause 2. The system of clause 1, wherein the flight route analysis control unit also receives contact data indicative of contacts for the flight routes to the destination airport

Clause 3. The system of any of clauses 1 or 2, further comprising a user interface in communication with the flight route analysis control unit, wherein the flight route analysis control unit presents the information and times for the flight routes via the user interface.

Clause 4. The system of any of clauses 1-3, wherein the flight route analysis control unit presents the contacts for the flight routes via the user interface.

Clause 5. The system of any of clauses 1-4, wherein the user interface is onboard an aircraft, and wherein the flight route analysis control unit is remote from the aircraft.

Clause 6. The system of any of clauses 1-5, wherein the user interface and the flight route analysis control unit are onboard an aircraft.

Clause 7. The system of any of clauses 1-6, wherein the flight route analysis control unit shows on a display of the user interface each of the flight routes to the destination, times to the destination for each of the flight routes, the overflight charges for each of the flight routes, the fuel costs for each of the flight routes, and the contacts for each of the flight routes.

Clause 8. The system of any of clauses 1-7, wherein the overflight charge data comprises entry fee data and distance traveled fee data indicative of a fee associated with entering airspace of each of the plurality of areas.

Clause 9. The system of any of clauses 1-8, wherein the overflight charge data comprises distance traveled fee data indicative of a charge for distance traveled within each of the plurality of areas.

Clause 10. The system of any of clauses 1-9, wherein the contact data comprises information regarding contacts for requesting permission to fly into and through an area.

Clause 11. A method comprising:

receiving, by a flight route analysis control unit comprising a processor, flight route data indicative of flight routes to the destination airport, overflight charge data indicative of overflight charges for the flight routes to the destination airport, and fuel costs data indicative of fuel costs for the flight routes to the destination airport; and

determining, by the flight route analysis control unit, total costs data indicative of total costs for the flight routes based, at least in part, on the overflight charge data and the fuel costs data.

Clause 12. The method of clause 11, wherein said receiving further comprises receiving contact data indicative of contacts for the flight routes to the destination airport

Clause 13. The method of any of clauses 11 or 12, further comprising facilitating, by the flight route analysis control unit, a presentation of the total costs and timing data indicative of times for the flight routes via a user interface in communication with the flight route analysis control unit.

Clause 14. The method of any of clauses 11-13, further comprising facilitating, by the flight route analysis control unit, a display of contact data indicative of the contacts for the flight routes on the user interface.

Clause 15. The method of any of clauses 11-14, further comprising:

providing the user interface onboard an aircraft; and

remotely locating the flight route analysis control unit from the aircraft.

Clause 16. The method of any of clauses 11-15, further comprising providing the user interface and the flight route analysis control unit onboard an aircraft.

Clause 17. The method of any of clauses 11-16, further comprising showing, by the flight route analysis control unit, on a display of the user interface each of the flight routes to the destination, times to the destination for each of the flight routes, the overflight charges for each of the flight routes, the fuel costs for each of the flight routes, and the contacts for each of the flight routes.

Clause 18. The method of any of clauses 11-17, wherein the overflight charge data comprises entry fee data and distance traveled fee data for a plurality of areas, wherein the entry fee data comprises information regarding fees for entering airspace of each of the plurality of areas, and wherein the distance traveled fee data comprises information regarding distance traveled fees within each of the plurality of areas.

Clause 19. The method of any of clauses 11-18, wherein the contact data comprises information regarding contacts for requesting permission to fly into and through an area.

Clause 20. A non-transitory computer-readable storage medium comprising executable instructions that, in response to execution, cause a flight route options determination system comprising a processor, to perform operations comprising:

receiving flight route data indicative of flight routes to the destination airport, overflight charge data indicative of overflight charges for the flight routes to the destination airport, and fuel costs data indicative of fuel costs for the flight routes to the destination airport;

based, at least in part, on the overflight charge data and the fuel costs data, determining total costs data indicative of total costs associated with the flight routes; and

facilitating a transmission of the total costs data to a user interface, wherein total costs data is to be displayed via the user interface,

wherein the flight route analysis control unit determines total costs for the flight routes based, at least in part, on the overflight charge data and the fuel costs data.

Clause 21. The non-transitory computer-readable storage of clause 20, wherein the overflight charge data comprises entry fee data and distance traveled fee data for a plurality of areas, wherein the entry fee data comprises information regarding fees for entering airspace of each of the plurality of areas, and wherein the distance traveled fee data comprises information regarding distance traveled fees within each of the plurality of areas.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a flight route analysis control unit that receives flight route data indicative of flight routes to a destination airport, overflight charge data indicative of overflight charges for the flight routes to the destination airport, and fuel costs data indicative of fuel costs for the flight routes to the destination airport,
wherein the flight route analysis control unit determines information indicative of total costs for the flight routes based, at least in part, on the overflight charge data and the fuel costs data.

2. The system of claim 1, wherein the flight route analysis control unit also receives contact data indicative of contacts for the flight routes to the destination airport

3. The system of claim 1, further comprising a user interface in communication with the flight route analysis control unit, wherein the flight route analysis control unit presents the information and times for the flight routes via the user interface.

4. The system of claim 3, wherein the flight route analysis control unit presents the contacts for the flight routes via the user interface.

5. The system of claim 3, wherein the user interface is onboard an aircraft, and wherein the flight route analysis control unit is remote from the aircraft.

6. The system of claim 3, wherein the user interface and the flight route analysis control unit are onboard an aircraft.

7. The system of claim 3, wherein the flight route analysis control unit shows on a display of the user interface each of the flight routes to the destination, times to the destination for each of the flight routes, the overflight charges for each of the flight routes, the fuel costs for each of the flight routes, and the contacts for each of the flight routes.

8. The system of claim 1, wherein the overflight charge data comprises entry fee data and distance traveled fee data indicative of a fee associated with entering airspace of each of the plurality of areas.

9. The system of claim 1, wherein the overflight charge data comprises distance traveled fee data indicative of a charge for distance traveled within each of the plurality of areas.

10. The system of claim 1, wherein the contact data comprises information regarding contacts for requesting permission to fly into and through an area.

11. A method comprising:
receiving, by a flight route analysis control unit comprising a processor, flight route data indicative of flight routes to the destination airport, overflight charge data indicative of overflight charges for the flight routes to the destination airport, and fuel costs data indicative of fuel costs for the flight routes to the destination airport; and
determining, by the flight route analysis control unit, total costs data indicative of total costs for the flight routes based, at least in part, on the overflight charge data and the fuel costs data.

12. The method of claim 11, wherein said receiving further comprises receiving contact data indicative of contacts for the flight routes to the destination airport

13. The method of claim 11, further comprising facilitating, by the flight route analysis control unit, a presentation of the total costs and timing data indicative of times for the flight routes via a user interface in communication with the flight route analysis control unit.

14. The method of claim 12, further comprising facilitating, by the flight route analysis control unit, a display of contact data indicative of the contacts for the flight routes on the user interface.

15. The method of claim 13, further comprising:
providing the user interface onboard an aircraft; and
remotely locating the flight route analysis control unit from the aircraft.

16. The method of claim 13, further comprising providing the user interface and the flight route analysis control unit onboard an aircraft.

17. The method of claim 13, further comprising showing, by the flight route analysis control unit, on a display of the user interface each of the flight routes to the destination, times to the destination for each of the flight routes, the overflight charges for each of the flight routes, the fuel costs for each of the flight routes, and the contacts for each of the flight routes.

18. The method of claim 11, wherein the overflight charge data comprises entry fee data and distance traveled fee data for a plurality of areas, wherein the entry fee data comprises information regarding fees for entering airspace of each of the plurality of areas, and wherein the distance traveled fee data comprises information regarding distance traveled fees within each of the plurality of areas.

19. The method of claim 11, wherein the contact data comprises information regarding contacts for requesting permission to fly into and through an area.

20. A non-transitory computer-readable storage medium comprising executable instructions that, in response to execution, cause a flight route options determination system comprising a processor, to perform operations comprising:
receiving flight route data indicative of flight routes to the destination airport, overflight charge data indicative of overflight charges for the flight routes to the destination airport, and fuel costs data indicative of fuel costs for the flight routes to the destination airport;
based, at least in part, on the overflight charge data and the fuel costs data, determining total costs data indicative of total costs associated with the flight routes; and
facilitating a transmission of the total costs data to a user interface, wherein total costs data is to be displayed via the user interface,
wherein the flight route analysis control unit determines total costs for the flight routes based, at least in part, on the overflight charge data and the fuel costs data.

21. The non-transitory computer-readable storage of claim 20, wherein the overflight charge data comprises entry fee data and distance traveled fee data for a plurality of areas, wherein the entry fee data comprises information regarding fees for entering airspace of each of the plurality of areas, and wherein the distance traveled fee data comprises information regarding distance traveled fees within each of the plurality of areas.
